(19) United States
(12) Patent Application Publication
(10) Pub. No.: US 2020/0377000 A1
(43) Pub. Date: Dec. 3, 2020

(54) TRAILER FOR DELIVERY OF PRODUCTS

(71) Applicant: Pickdelso Oy, Vantaa (FI)

(72) Inventor: Tapio Saviranta, Vantaa (FI)

(73) Assignee: Pickdelso Oy, Vantaa (FI)

(21) Appl. No.: 16/882,506

(22) Filed: May 24, 2020

Related U.S. Application Data
(63) Continuation of application No. PCT/EP2018/025299, filed on Nov. 26, 2018.

(30) Foreign Application Priority Data
Nov. 26, 2017 (FI) 20176060
Nov. 25, 2018 (AU) 201810823

(51) Int. Cl. B60P 3/00; B62D 21/02; B62D 33/04; G05D 1/02; B60S 9/04

(52) U.S. Cl. CPC B60P 3/007; B62D 21/02; B60S 9/04; G05D 1/0225; B62D 33/042

(57) ABSTRACT

An invention relates to picking, loading, and transporting of products. One objective is to reduce or eliminate manual work, or unnecessary process stages. The invention concerns a trailer for a delivery of the products, wherein the trailer comprises an attachment point for attaching the trailer to a road vehicle, a body with wheels, and a wall attached to the body. The wall includes openings to a trunk that is limited by at least the body and the wall. The trailer comprises closures to cover and expose the openings, and the trailer is configured to open a closure in response to a correct identifier. The trailer is further configured to receive a frame to a storing place in the trunk so that, at the storing place, the frame holds a first repository besides a first opening and a second repository besides a second opening. The frame comprises a contact part for one of the following devices capable to propel the frame: a stationary loading device or an automated guided vehicle (FIG. 1).

### TECHNICAL FIELD

Area of technology: an invention relates to picking or sorting of products, and loading, transporting, and delivering of the products; the invention especially relates to manners to reduce or eliminate manual work or process stages.

### BACKGROUND

Postal parcels are one example of items which are picked and placed (by employees) into storage places. The storage places are located, for example, in a frame that is a part of a fixed packet automaton described in WO2016185094, or a frame is a part of a moveable packet automaton described in WO2018046603. An alternative term for a set of storage places is “SKU”. In the field of inventory management a stock keeping unit (SKU) is a distinct type of item for sale but the term SKU also refers to a device that is intended for storing and moving items. A corresponding device is termed an “inventory holder” in US2008166217 and said publication describes a robot that is also known as an automated guided vehicle (AGV). AVGs are intended for moving or propelling inventory holders and they are used in logistics tasks, for example, in industry and in warehouses.

Products can be ordered from internet and later on the products are delivered, for example, to the homes of the subscribers. The service for delivering the products to the subscribers includes stages of which the first one is either a picking stage or a sorting stage. The picking stage can be implemented in accordance with a man-to-goods principle. Then a collector, i.e. an employee who performs the picking stage, moves a picking cart sometimes long distances and collects products into it. Alternatively, the picking stage can be implemented in accordance with a goods-to-man principle. Then a collector stands on a certain place and goods are automatically moved to the proximity of the collector.

In sorting centres the delivery process starts with a sorting stage. The sorting stage concerns parcels or (postal) packets. The sorting stage is usually implemented such that an employee collects parcels from a conveyor line and places the parcels into correct lockers of a post sorting shelf. Because each parcel includes at least one product, the delivery process can be considered to concern products. Various automatons have been developed for delivery of products. Some of the automatons are termed“grocery lockers” because they are intended for delivering grocery products. Correspondingly, some automatons are made for delivering laundry. Also clothes and other laundry items can be termed products.

In various services a collector places products into totes and after that the totes are lifted with hands into the lockers of the automaton. This task, i.e. lifting of the totes, can be eliminated by using one the following systems.

DE19716138 describes a system in which lockers are arranged in a cart, or a plurality of carts, and the locker doors form a wall so that the lockers are reachable through the locker doors.

U.S. Pat. No. 7,407,238 describes a system comprising a cart with shelves and a wall with doors so that the shelves of the cart are reachable through the doors. The systems described in the above-mentioned DE19716138 and U.S. Pat. No. 7,407,238 have such drawback that the carts used in them are not intended for picking products into totes and therefore they are impractical, for example, in a delivery of grocery products.

The applicant's prior patent application, PCT/FI2016/050335 describes a locker system that reduces needs to move totes, because a cart to be used in the system is intended for picking grocery products or other small-sized products directly into the totes.

DE 102010023603 describes a mobile safe-deposit box system for delivering, for example, odorous fresh vegetables. DE202004001562 describes a mobile locker system, particularly for accommodating utility items used on beaches, such as air mattresses, parasols, or similar EP1155913 describes a storage system comprising a wheeled structure that carries a plurality of closable compartments.

The three last-mentioned publications describe trailers which resemble more or less locker systems. In these publications, filling of lockers includes a lot of manual work because the lockers are fixed lockers and they need to be filled one by one. Therefore, the manual loading of a locker system is one drawback in the prior art. This type of locker system is also termed a “packet automaton”, or shortly an automaton.

Another drawback is that the prior art packet automatons are dependent on mains power at a delivery site.

Another drawback is a common conception that a temporary storage is an obligatory investment in a building where the products are sorted or picked. Use of the temporary storage causes a process stage which may be waste in the process and can be therefore termed an “additional storing stage”.

Another drawback is that manually movable carts require relative much labour. Manually movable carts are used in trailers described in PCT/EP2017/072473. Automated guided vehicles (AGV) can be used instead of labour to move carts inside a building.

U.S. Pat. No. 4,972,917 describes an AVG intended for propelling carts on a floor of a building. U.S. Pat. No. 8,280,547 describes such AVG that can lift a shelf (an inventory holder) up from a floor and then propel the shelf to another place.

### SUMMARY

The invention is especially intended for a business in which products are delivered from a picking site or a sorting site to a number of delivery sites. An objective of the invention is to solve at least the above-mentioned drawback related to the manual loading of a locker system.

In the present innovation a cart means a device whose wheels carry the whole mass of the cart. Each cart comprises a frame and the frame comprises repositories for products to be delivered. Frames can be propelled with automated guided vehicles (AGVs) and thus it is not necessary to use carts with a trailer operating as a locker system.

Alternatively, frames can be propelled with a stationary loading device, such as a conveyor belt. If a frame has a flat bottom, it may be possible to propel the frame with an AGV or with the stationary loading device.

The invention concerns a trailer for a delivery of products, the trailer comprising an attachment point for attaching the trailer to a road vehicle, a body with wheels, a wall attached to the body, the wall including openings to a trunk that is limited by at least the body and the wall, and closures to cover and disclose the openings, and the trailer is configured to open at least one of the closures in response to a correct identifier input or provided by a customer, and the trailer is configured for the delivery so that a first repository in the trunk is reachable only through a first opening and a second repository in the trunk is reachable only through a second opening.

The trailer further comprises a frame including in the first repository and the second repository, the frame comprising a contact part for at least one of the following devices capable to propel the frame: a) a stationary loading device, b) an automated guided vehicle; and the trailer is configured to receive the frame to a storing place so that, at the storing place, the frame holds the first repository besides the first opening and the second repository besides the second opening.

In one aspect the trailer the trailer comprises in the trunk a location marking and the automated guided vehicle is adjusted to leave the frame at the location marking.

In one aspect the trailer the trailer comprises a frame entry for moving the frame into the trailer and out of the trailer.

In one aspect the trailer the trailer comprises a loading bridge at the frame entry.

In one aspect the trailer the trailer comprises a motion detector capable to detect the automated guided vehicle and the trailer is configured to open the frame entry to for the automated guided vehicle.

In one aspect the trailer the trailer comprises the frame with wheels.

In one aspect the trailer the trailer comprises the frame with legs.

In one aspect the trailer the trailer comprises rollers on a floor of the trunk to move the frame.

In one aspect the trailer the trailer comprises the frame whose bottom plate operates as the contact part for the stationary loading device and the rollers on the floor of the trunk.

In one aspect the trailer the repositories of the trailer are intended for delivery of at least one of the following items: shopping bags, laundry bags, boxes, parcels.

### BRIEF DESCRIPTION OF THE DRAWINGS

For a more complete understanding of examples and embodiments of the present invention, reference is now made to the following descriptions taken in connection with the accompanying drawings.

FIG. 1 shows an example of a trailer.

FIG. 2 shows the trailer from a bird's perspective.

FIG. 3 shows the trailer from the back side.

FIG. 4 A shows a cart in picking use.

FIG. 4B shows a fastener for the cart.

FIG. 5 shows a repository set for the cart.

FIG. 6 shows a second trailer example.

FIG. 7A shows a third trailer with lockers.

FIG. 7B shows the third trailer from a bird's perspective.

FIG. 7C shows a cart and a trailer for parcels.

FIG. 8 shows an example of a semi-trailer.

FIG. 9A shows an example of a semi-trailer for delivery of boxes.

FIG. 9B shows an example of a frame and a stationary loading device

FIG. 10A shows an example of a frame and an automated guided vehicle.

FIG. 10B shows two examples of frames and AVGs.

FIG. 11 shows implementation details of a trailer.

### DETAILED DESCRIPTION OF THE INVENTION

It is appreciated that the following embodiments are exemplary. Although the specification may refer to “one” embodiment, the reference is not necessarily made to the same embodiment(s), or the feature in question may apply to multiple embodiments.

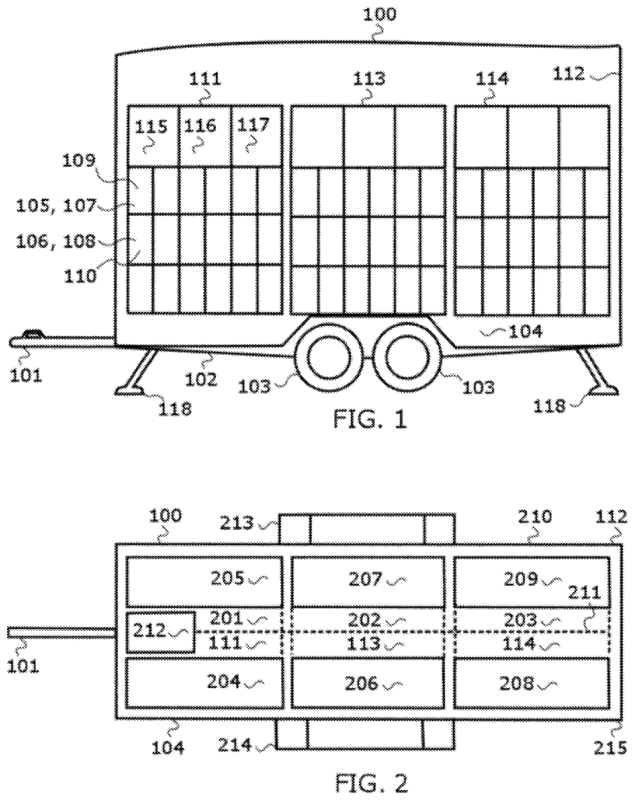

FIG. 1 shows an example of a trailer 100 for totes, wherein trailer 100 is viewed from its long side. Trailer 100 can be considered as a movable automaton that is intended for storing and delivering of products in totes. The products are, for example, grocery products, electronic products, clothes etc. A tote is, for example, a shopping bag, a laundry bag, or a (postal) parcel or package. Trailer 100 comprises an attachment point 101 for attaching trailer 100 to a road vehicle, such as a pick-up, an off-road vehicle, or a crossover car. Attachment point 101 is, for example, a part into which the coupling hook of the vehicle fits. Trailer 100 comprises a body 102 having at least two wheels 103. Attachment point 101 may be coupled to trailer body 102 with a beam as in the figure.

Trailer 100 comprises a wall 104 attached to body 102, and openings 105, 106 to repositories that are intended for storing totes. Openings 105, 106 are located in wall 104 so that a first repository 107 is reachable only through a first opening 105 and a second repository 108 is reachable only through a second opening 106 when a cart containing the first repository and the second repository is received into trailer 100. When using the same cart in a delivery of the products unnecessary moving of the products can be avoided.

Body 102 can be understood as a steel frame or a chassis that is generally used in trailers. Wall 104 can be understood as a part of a coachwork that is (permanently) attached to body 102. A steel plate, an aluminium plate, or weatherproof plastic is an appropriate surface material for wall 104. Wall 104 includes closures 109, 110 to cover and expose openings 105, 106. A basic example of closure 109, 110 is a hinged hatch that can be termed a locker door. Closures 109, 110 are openable with a code (such as a pin number) so that when a customer inputs or provides the correct code, at least one locker door will open and the customer can take his/hers tote/totes out of trailer 100. Because repositories 107, 108 are intended for one tote, the customer's purchases may require a number of repositories.

In one embodiment the all closures 109, 110 of the repositories will open when a customer provides a correct identifier (such as a pin number). The correct identifier can be provided wirelessly, for example, by using Near Field Communication (NFC) techniques. In another embodiment the closures will open one by one so that the next closure 110 will open when a previously opened closure 109 is closed.

Each storing place inside trailer 100 can receive one cart. Trailer 100 is configured to receive the cart to storing place 111 beside wall 104 so that the first repository 107 is reachable through the first opening 105 and the second repository 108 is reachable through the second opening 106. Trailer 100 comprises a frame entry 112 for moving a frame into trailer 100 and out of trailer 100. Frame entry 112 is not visible in the figure but it is located on a back end of trailer 100. After a picking stage the products picked are moved in frames through frame entry 112 into trailer 100. In addition to storing place 111, there are two other storing places 113, 114 for carts on same side of trailer 100. Therefore, wall 104 includes in this example altogether 63 openings, such as openings 105, 106, on its long side and as many closures, and repositories so that the openings, the closures, and the repositories are divided between three carts, each of the three carts having twenty-one repositories. Eighteen of those twenty-one repositories are especially intended for shopping bags, but the three repositories locating the uppermost in the cart may include products in a package. A toilet paper package is an example of said products. Closures 115-117 cover accesses to the three uppermost repositories.

After the picking state trailer 100 includes at least one cart and it will be transported to a delivery site and parked there. In more detail, trailer 100 is detached from the road vehicle and left, for example, on a parking lot for a predetermined period of time that is termed a “delivery time window”. One benefit of trailer 100 is that it operates as an unmanned delivery point. When the delivery time window is ended, and the all totes are expected to be fetched (by customers), trailer 100 (and the carts inside it) will be transported back to the same picking site, or some other picking site.

In this example closures 109, 110, 115-117 and the rest of the closures are in their closed position, trailer 100 is parked, and customers can fetch their totes from trailer 100. Trailer 100 is configured to open by using a computer unit and an electric lock a closure, such as closure 109, in response to providing a correct (visual or electrical) identifier. Trailer 100 has altogether four legs 118 on which trailer rests when parked.

Legs 118 are intended to be used at the picking site and at each delivery site. The legs are lifted up during trailer transportation. By using legs 118, the trailer floor can be set on a horizontal plane even if the parking plot is bumpy or tilted to some direction.

FIG. 2 shows a cross-section of trailer 100, wherein trailer 100 is viewed from a bird's perspective. Trailer 100 includes altogether six storing places 111, 113, 114, 201-203 for the carts, three storing places on each long side of trailer 100. The all storing places 111, 113, 114, 201-203 are in use, because six carts 204-209 are received in said storing places. For example, cart 204 (a frame 204) is received in storing place 111.

Storing place 111 must have some attachment arrangement to attach cart 204 so that the transportation does not cause any damage in the trunk of trailer 100. The attachment arrangement may comprises attachment points on the trunk and cargo straps by which cart 204 is tied to the attachment points to hold cart 204 on its storing place. Alternatively, the attachment arrangement may comprise a steel pipe that can be locked to wall 104 and a corresponding wall 210 on the other long side of trailer 100 so that cart 204 can neither move in the trunk towards the front end of trailer 100 nor towards the back end of trailer 100. Said steel pipe may include a hook type of part for holding cart 204 and preventing cart 204 to tilt towards cart 205. As wall 104, also wall 210 has altogether 63 closures to cover and expose as many openings to the repositories, wherein the repositories are located in carts 205, 207, 209 so that each of the carts includes twenty-one repositories. Open space 211 in the trunk continues from the back end of trailer 100 to its front end and is useful for circulating air inside trailer 100. A cooling apparatus 212 at the front end cools the air and circulates it to maintain a refrigerator temperature in the trunk. If the climate is cold, a heating apparatus can maintain an appropriate temperature.

The following cart and trailer measurements are examples. Cart 204 is 55 cm width on the level of the cart wheels to keep cart 204 in balance when moving it. Cart 204 is 35 cm width over the cart wheels, wherein the width of 35 cm is the same as the width of a tote. Open space 211 between carts is 40 cm width. Each wall 104, 210 is 5 cm thick because of a thermal insulation layer. Therefore, the width of the trunk from the outer surface of wall 104 to outer surface of wall 210 is 120 cm. Because wheels 103 extend outside of the trailer body, the width of trailer 100 from a mudguard 213 to another mudguard 214 on the opposite side of trailer 100 is about 160 cm. Each cart is 120 cm long and the carts are situated at two queues so that carts 204, 206, and 208 form one queue and carts 205, 207, and 209 form another queue. Each cart queue includes three carts and is thus 360 cm long. The back end of trailer 100 is closed with a 110 cm width pair of doors 215. Pair of doors 215, as well as the front end of trailer, is 5 cm thick because of the thermal insulation layer. The beam of trailer 100 is 80 cm long. Therefore, the length of trailer 100 from the top of the beam to pair of doors 215 is about 450 cm, and trailer 100 can be parked to a parking lot that is 5 m long and 2.5 m width.

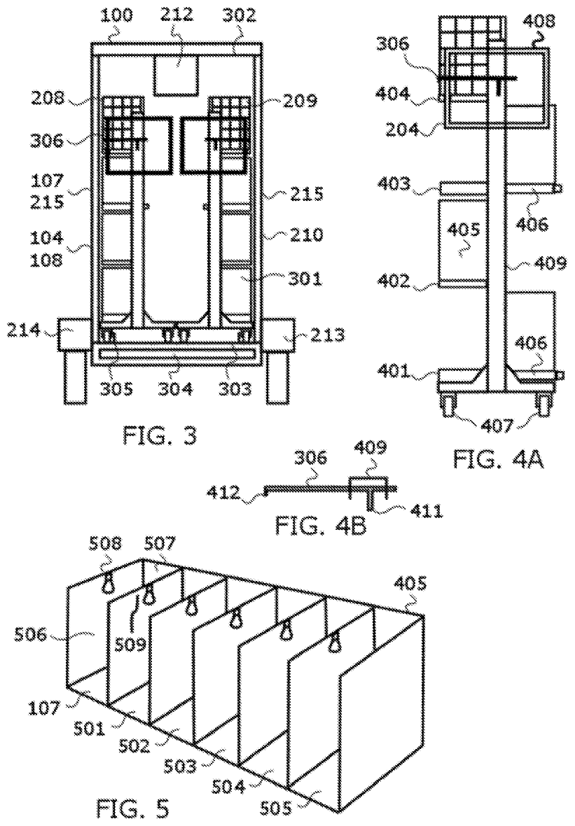

FIG. 3 shows trailer 100 from the back side. Pair of doors 215 is in the open position and thus carts 208, 209, which are placed into the trunk of trailer 100, are visible. Trailer 100 comprises repositories on its both walls 104, 210. For example, repository 301 is reachable through wall 210 when cart 209 is received into trailer 100. Loading of trailer 100 can be performed at the picking site by using a loading platform and a light loading bridge between trailer 100 and the loading platform. The loading bridge may be a hinged aluminium plate that is light enough to be used by hands.

The following cart and trailer measurements are examples. The height of carts 208, 209 is 170 cm. The height of the trunk is 200 cm and cooling apparatus 212 is located between two carts at the front end of trailer 100. Therefore, the trunk is so large that a delivery vehicle driver can enter into it when loading or unloading trailer 100. The ceiling 302 and the floor 303 of trailer 100 include the thermal insulation layer. Floor 303 further includes a space for an accumulator 304. Cooling apparatus 212 can function with accumulator 304 and therefore trailer 100 is independent from mains power, at least during the transportation from a picking site to a delivery site.

In one embodiment trailer 100 is independent from mains power also at the delivery site by utilizing accumulator 304. Closures 109, 110 of repositories are configured to operate on accumulator 304. When trailer 100 is transported from the delivery site back to the picking site it is connected to mains power, after which cooling apparatus 212 functions with the mains power and accumulator 304 is recharged.

In one embodiment trailer 100 comprises the following attachment arrangement to hold cart 208 on its storing place 114. The attachment arrangement includes a mechanical guide 305 and a fastener 306, and guide 305 is configured to touch cart wheels to keep cart 208 against wall 104 and fastener 306 is configured to lock cart 208 to ceiling 302 so that cart 208 stays on its storing place 114. Guide 305 is a steel plate attached to floor 303. In one embodiment fastener 306 is a barrel bolt by which cart 208 can be attached to wall 104. Wall 104 includes a hole for the barrel bolt. When pushed into the hole and then turned 90 degrees the barrel bolt locks cart 208 to wall 104 and prevents cart 208 from falling towards cart 209 during transportation of trailer 100. Guide 305 continues from frame entry 112 to the front end of trailer 100 and wall 104 includes holes for barrel bolts so that carts 204, 206 can be held on theirs storing places 111 and 113. Carts 205, 207, 209 on the opposite side of the trunk can be held on theirs storing places 201-203 by using a corresponding guide and barrel bolts.

FIG. 4A shows cart 209 in picking use, wherein cart 209 is viewed from its short side. Cart 209 also represents the other corresponding carts, i.e. carts 204-208. Any of carts 204-209 can be placed to any of storing places 111, 113, 114, 201-203.

Cart 209 comprises four shelves 401-404 of which the lowest shelf 401 and the third shelf 403, counting from below, are movable shelves and the other two shelves 402, 404 are fixed shelves. The first repository 107 is located on movable shelf 403. The uppermost shelf, i.e. shelf 404, includes steel mesh on three sides so that the both short sides have the steel mesh and also the long side locating farer from wall 104. Dividing walls divide shelf 404 into three repositories which are located besides closures 115-117. The dividing walls are made of steel mesh or transparent plastic plates, for example. Each of shelves 401-403 includes a repository set for six totes. Each repository in a repository set 405 is configured to support a tote. Thus, during the picking stage, the mouth of the tote is continuously at least partly exposed to receive the products into the tote.

Each movable shelf 401, 403 comprises a displacer 406 which is, for example, a pair of a drawer slides or a pair of slide rails. A telescopic drawer may include three nested slides. Cart 209 is configured for picking so that displacers 406 have an open position and they remain in the open position when cart 209 is moved during the picking. When in an open position displacer 406 and moveable shelf 403 reveal repository set 405 of fixed shelf 402 so that products can be picked in the repositories of repository set 405.

At least two of the cart wheels 407 can turn in order to make cart 209 guidable. Cart 209 includes fixed handles 408 for pushing and guiding the cart. A durable material, such as steel, is an appropriate material for the body of cart 209. The cart body includes U profile 409 and a corresponding U profile at the opposite end of cart 209. It should be noticed that in FIG. 3 the all carts, including cart 209, are narrowed. In other words, cart 209 is changed from the picking use to the delivery use so that moveable shelves 401, 403 are pushed to their opposite position in which they are located besides wall 104. Balanced loading of the carts is described in WO2018046603.

FIG. 4B shows fastener 306 for cart 209, wherein fastener 306 is viewed from a bird's perspective. Fastener 306 is about 40 cm long barrel bolt that penetrates U profile 409 in two points. In more detail, U profile 409 includes two holes so that fastener 306 can be moved along a line defined by said two holes. Fastener 306 includes a handle 411 for moving the fastener along the line and a protrusion 412 for locking cart 209 to a wall of trailer 100.

Handle 411 is in a horizontal orientation because in this orientation protrusion 412 can be pushed inside the wall. Then handle 411 can be turned to a vertical orientation to lock cart 204 (in FIG. 3 protrusion 412 is located inside wall 104 and cart 209 is locked and ready for the transportation).

FIG. 5 shows repository set 405 intended for carts 204-209. Repository set 405 includes repository 107 and five other similar repositories 501-505. Said repository 107 includes a side opening 506 and an upper opening 507. Upper opening 507 opens upwards relative to the bottom of repository 107. Side opening 506 means that one short side is missing from repository 107. A tote (and the products placed in the tote) can be taken through side opening 506 out of repository 107.

Repository 107 comprises holders 508, 509 for holding at least one handle of the tote so that holder 508 is located on the upper edge of a long side of repository 107 and holder 509 is located on the upper edge of the opposite long side (holder 509 is not visible in the figure). For example, carabiners can be used as holders 508, 509. In one embodiment a system unit for picking and storing of products is one tote.

The small unit size increases the statistical storage capacity approximately 100% compared to the known systems in which the system unit is larger, for example, 701.

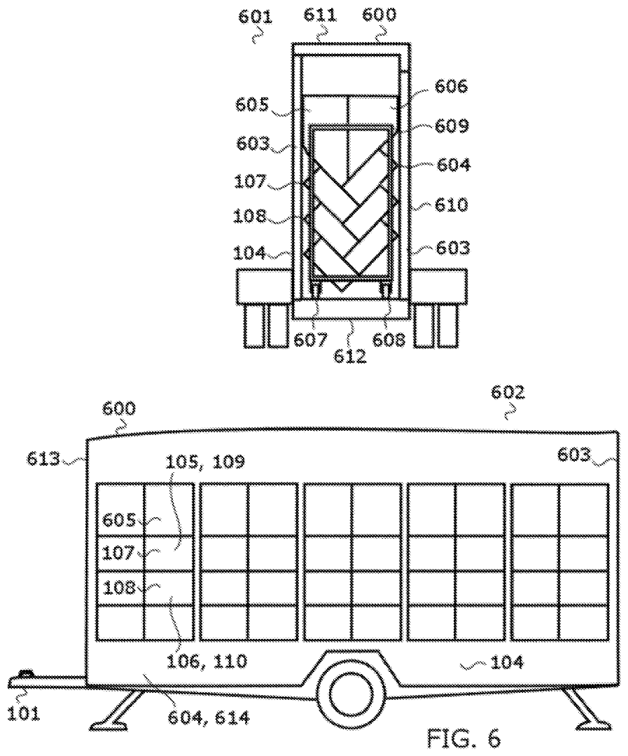

FIG. 6 includes an example of trailer 600 that is used with picking carts and trailer 600 is illustrated in a first view 601 and in a second view 602. The first view 601 shows trailer 600 from the back. Pair of doors 603 is in the open position and thus a cart 604 (a frame 604) is visible in the trunk of trailer 600. The first repository 107 is tilted to keep its content inside of it. Cart 604 includes repositories which are tilted to at 45 degrees angle in relation to the horizontal plane. The repositories are made of perforated steel plate, for example. When washing them, the wash water drips through the perforation out of the repositories. The uppermost repositories 605, 606 are intended for light products and they are larger than the repositories locating under them. The most repositories, such as repositories 107, 108, are intended for shopping bags. Cart 604 has wheels 607, 608 and a handle pipe 609 for moving and guiding cart 604. Cart 604 extends from wall 104 to a corresponding wall 610. The both walls 104, 610 include openings for the repositories. The trunk of trailer 600 has a space for a cooling apparatus in the proximity of the ceiling 611. The floor 612 of the trunk is thick enough to enclose an accumulator inside it.

The following cart and trailer measurements are examples. The height of cart 604 is 150 cm, the width is 60 cm, and the length is 80 cm. The height of the trunk is 160 cm, the width is 61 cm, and the length is 401 cm. The all five carts are kept in the trunk during transportation, because the carts fill the trunk so that they cannot move horizontally when pair of doors 603 is closed. A benefit of this embodiment is that no separated attachment arrangement is needed. Because the trunk is low (160 cm) and narrow (61 cm), a person loading cart 604 can utilize about 350 cm long rod with a hook at one of its end so that the person grips handle pipe 609 with the hook and uses the rod to push cart 604 into trailer 600. The rod with the hook can be utilized also when unloading trailer 600.

The second view 602 shows trailer 600 from its long side. Cart 604 is pushed against a front wall 613 and against wall 104 and therefore cart 604 is located in a storing place 614. For example, repository 107 in the trunk is reachable through opening 105 after providing a correct code or another identifier, such as a linear barcode or as a matrix barcode. The correct identifier opens closure 109 and grants an access to repository 107. The lower edge of the uppermost repository 605 is located (in this example) at the height of 160 cm from the ground.

As cart 204, also cart 604 may be parked for a time at a picking site. A benefit related to the parking is that cart 204, 604 can be used as storage for totes. In more detail, when products are picked into the totes, and the picking stage ends, cart 204, 604 is moved into trailer 100, 600. When a driver arrives to the picking site, he/she just attaches trailer 100, 600 to the road vehicle and transports it to a delivery site. In other words, there is no need to move the carts and the products after the picking stage into a chilled room and later on from the chilled room into a delivery vehicle.

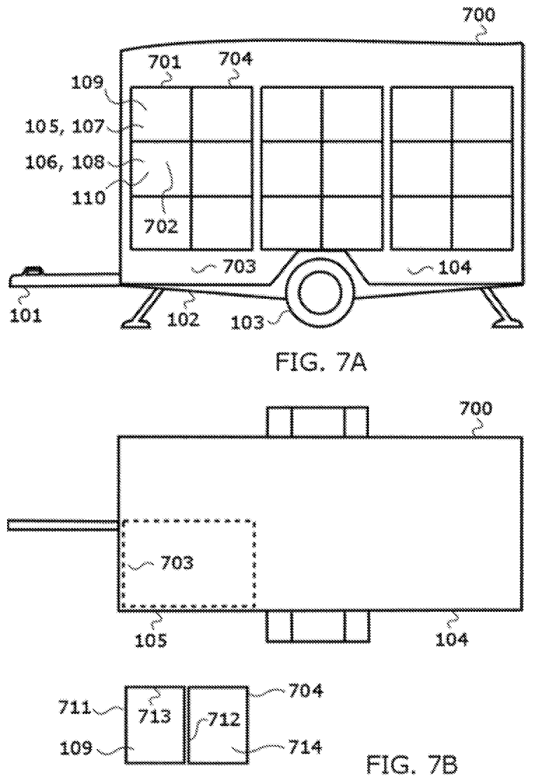

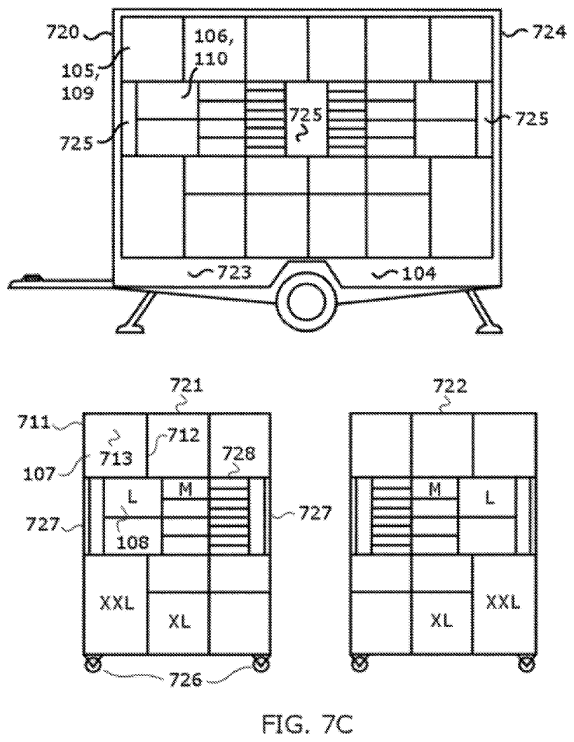

FIG. 7 A shows an example in which a trailer 700 is viewed from its long side. Trailer 700 comprises lockers, such as lockers 701, 702. A locker 701 comprises the first repository 107 and the first closure 109. A locker 702 comprises the second repository 108 and the second closure 110.

Trailer 700 comprises wall 104 with openings 105, 106 to repositories 107, 108 and, as in the previous embodiments, trailer 700 comprises storing places for carts. A cart 704 (a frame 704) is received into trailer 700, into a storing place 703. Cart 704 includes repositories 107, 108 and four other repositories for products to be delivered.

In one embodiment lockers 701, 702 are thermally isolated from each other and an ambient with theirs closures 109, 110. For example, if closure 109 is left open, intentionally or unintentionally, the temperature in locker 701 cannot be controlled anymore but the temperature in the rest of the lockers in trailer 700 can still be controlled.

In one embodiment locker 701, i.e. repository 107, can receive a box having measures 60×40×30 cm and handles for lifting it. The box includes one or more products to be delivered to a customer. In one embodiment each repository, such as repository 107 can receive at least one product without any box. Cart 704 is a picking cart such that products to be delivered are picked into its repositories, for example, in a store.

In one embodiment trailer 700 and its lockers are intended for laundry bags. When a customer has collected, for example, from locker 701 in a laundry bag including washed and dried clothes, the customer may place another laundry bag including dirty clothes in locker 701 to be delivered to a launderette. In one embodiment trailer 700 and its lockers are intended for parcels. A parcel in locker 701 includes at least one product. The sender of the parcel may be a manufacturer of said at least one product, or the sender is, for example, a web shop. In this embodiment the parcel is delivered by a post or a courier company.

FIG. 7B shows trailer 700 and cart 704 from a bird's perspective. The first repository 107 in cart 704 comprises a bottom, a ceiling, two side walls 711, 712, an opening, and a back wall 713 opposite to the opening, and corresponsive repository 714 locates besides repository 107. Cart 704 is appropriate for boxes or laundry bags. Storing place 703 for a cart in trailer 700 is marked with dashed line. Trailer 700 comprises opposite to wall 104 a corresponding wall 715 including openings to repositories. Trailer 700 can receive altogether six carts, each having six repositories. Each repository can receive, for example, one box whose mouth is 60×40 cm and height 35 cm.

FIG. 7C shows a trailer 720 and two carts (or frames) 721, 722 for delivering parcels, wherein trailer 720 and carts 721, 722 are viewed from theirs long side. Trailer 721 comprises a storing place 723 besides wall 104 for cart 721 and another storing place for cart 722 and, opposite to wall 104, two storing places besides a corresponding wall 724 for two other carts. Wall 104 surrounds the long side of trailer 721 and wall 104 further includes rectangular form of plates 725. The other rectangles in FIG. 7C illustrate locker doors, including closures 109, 110. Cart 721 comprises wheels 726 for moving it and four handles 727 for handling cart 721. Repository 107 in cart 721 comprises a bottom, a ceiling, two side walls 711, 712, an opening, and back wall 713 opposite to the opening. The repositories are of various sizes so that a repository 728 represents the smallest repository ‘S’ in cart 721. The other repository sizes from smallest to largest are marked ‘M’, ‘L’, ‘XL’, and ‘XLL’. The other cart in FIG. 7C, i.e. cart 722, comprises repositories whose positioning is a mirror image of the repositories of cart 721.

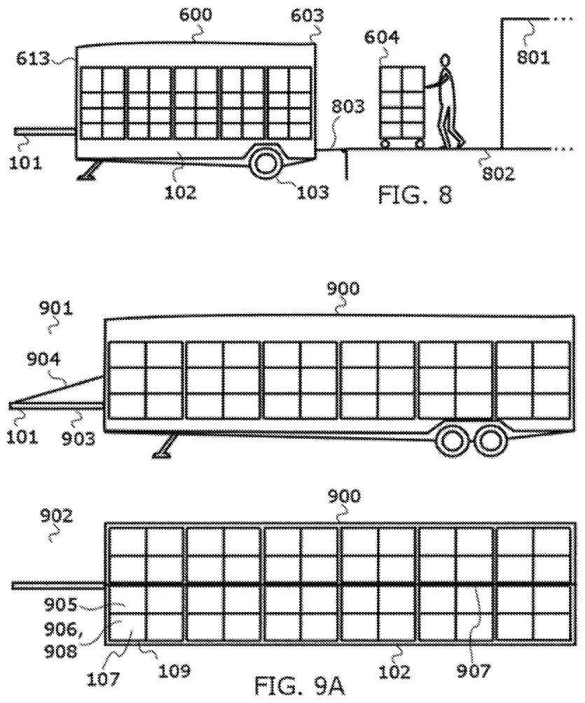

FIG. 8 shows an example of trailer 600 when it is implemented as a semi trailer. When a picker (an employee) has picked in a building 801 products into cart 604, the picker pushes cart 604 via a loading platform 802 and via a hinged loading bridge 803 into trailer 600. After that the same picker or another picker may push another cart(s) into trailer 600. Trailer 600 operates as the temporary storage for at most five carts and during that time its accumulator is recharged. When a driver arrives with a road vehicle to the picking site, the driver disconnects trailer 600 from mains power, attaches trailer 600 to the road vehicle, and transports it to a delivery site.

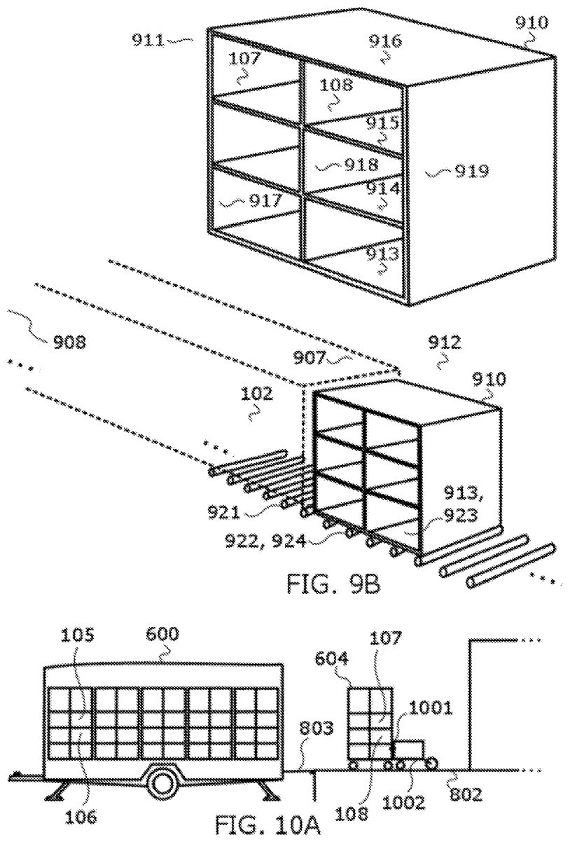

FIG. 9A shows trailer 900 in a first view 901 and in a second view 902. The length of trailer 900 is almost ten meters.

In the first view 901 Attachment point 101 is a type of attachment point used in semi-trailers and it is connected to a beam 903. Beam 903 and its support 904 are attached to the front wall of the trailer so that attachment point 101 is located at least 80 cm from the ground. Then a road vehicle can be reversed under attachment point 101 for moving the trailer. In one embodiment closure 109 is an automatically closable closure. In the prior art automatons a closure is usually a hinged hatch that opens to the right or to the left. Those hatches have certain drawbacks. A first drawback is that a customer hurt himself/herself to the hatch when the hatch is opened. A second drawback is that the prior art hatch cannot be closed by the automaton/trailer, if the customer forgets to close the hatch. This drawback especially concerns trailers intended for temperature controlled products. A roller door is used in the prior art, for example, as a door of a car garage. An electric motor, pneumatic apparatus, or another type of activator with various, generally known hatch, folding door, sliding door, or roller door implementations can be utilised as an automatically closable closure 109. The second view 902 shows the same trailer as the first view 901 but here from a bird's perspective without a roof and without top plates of frames. Each repository can receive two boxes of size 60×40×35 cm so that the long sides of the boxes touch each other. For example, boxes 905, 906 are located in the first repository 107 and they are reachable by opening closure 109. Second repository 108 is located beside the first repository 107. The long sides of the boxes are parallel with wall 102, i.e. the long side of trailer 900. Frames are located in two lines inside the trailer, in six frames per a line. The maximum number of boxes is 144. A dividing wall 907 is parallel with wall 102 and divides the trunk of trailer 900 into two as large departures. A storing place 908 for a frame is located in the front part of the trailer trunk.

FIG. 9B shows a frame 910 in a first view 911 and rollers on the trailer floor and rollers on the storage floor in a second view 912.

The first view 911 shows frame 910 and its repositories including the first repository 107 and the second repository 108. Frame 910 is composed of plates that form altogether six repositories, including the first repository 107. The repositories are intended for delivery of boxes but the boxes are omitted in this view. A bottom plate 913, a second plate 914, a thirst plate 915 and a top plate 916 are horizontal plates. A first end plate 917, a dividing plate 918, and a second end plate 919 are vertical plates. First repository 107 and the five other repositories extend through frame 910.

The second view 912 shows loading frame 910 when the trunk of trailer 900 is empty. Frame 910 is arriving from a loading dock into the trunk departure (dashed line) between wall 102 and dividing wall 907. The trunk floor and the loading dock floor are located on the same horizontal level and they both include rollers. At least some of the rollers are motorised to move frame 910 into the trunk and towards storing place 908. For example, a roller 921 is located on the trunk floor and a roller 922 is located on the loading dock floor. Bottom plate 913 of frame 910 operates as a contact part 923 for a stationary loading device 924. Bottom plate 913 further operates as contact part 923 for rollers, including roller 921, on the trunk floor to move trailer 900 into the trunk and out of the trunk. For example, rubber can be used on the surface of the rollers or bottom plate 913 to increase the friction between them.

Rollers or a conveyor belt are examples of a stationary loading device. Stationary loading device 924 has rolling or moving parts, such as roller 922, but the body of it does not move. Therefore, stationary loading device 924 is a contrast to an automated guided vehicle (AGV) whose body moves when it conveys some item. The automated guided vehicle can also be termed a robot that has an ability move from one location to another. There are also robots which are stationary devices like stationary loading device 924. For example, a robot hand has usually a fixed location.

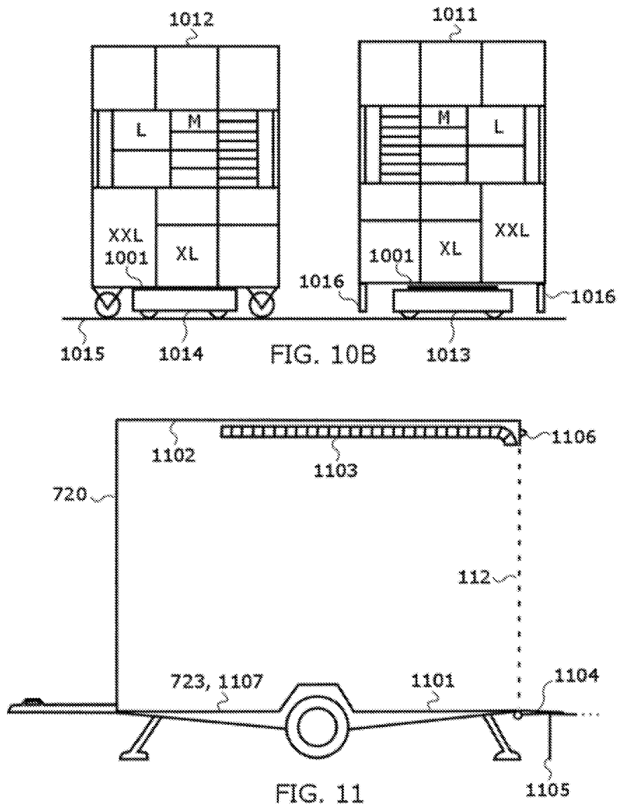

FIG. 10A shows trailer 600 for a delivery of products when using an AVG. Trailer 600 is otherwise the same as in FIG. 6 but in this example trailer 600 comprises such frame 604 which has a contact part 1001 for an AGV 1002. Alternatively, frame 204, frame 721, or frame 722 could have contact part 1001 for AGV 1002. AGV 1002 comprises two fixed wheels to propel AGV 1002 on a floor, one greater wheel in the rear of the body, and two grapples. AGV 1002 has attached with the grapples to contact part 1001. Contact part 1001 in this example a support structure in frame 604 comprising two vertical pipes connected with two horizontal pipes. Loading platform 802 and loading bridge 803 are substantially on the same height as the trunk floor of trailer 600 to enable loading of trailer 600. Trailer 600 is configured to receive frame 604 (propelled by AGV 1002) to a storing place so that frame 604 holds the first repository 107 besides the first opening 105 and the second repository 108 besides the second opening 106.

FIG. 10B shows two examples of frames 1011, 1012 and two examples of AVGs 1013, 1014. AVG 1014 is such AVG model that fits between a floor 1015 and the bottom of frame 1012 and is configured to propel frame 1012. AVG 1014 attaches itself to the bottom of frame 1012. In more detail, the bottom of frame 1012 includes holes into which AVG 1014 can push pegs to propel frame 1012. The holes in the bottom of frame 1012 operate as contact part 1001 for AVG 1014. Correspondingly, AVG 1013 is such AVG model that fits between floor 1015 and the bottom of frame 1011 and is configured to move frame 1011 by attaching itself to the bottom of frame 1011. Pegs on the bottom of frame 1011 operate in this example as contact part 1001 for AVG 1013. AVG 1013 comprises a round plate with holes such that the holes suit for contact part 1001 of frame 1011. The holes and pegs can be omitted, if there is enough friction between the bottom of the frame and the AGV. AVG 1013 is capable to lift frame 1011 up using the round plate. When four legs 1016 of frame 1011 are detached from floor 1015 AVG 1013 can propel frame 1011 on floor 1015.

FIG. 11 shows trailer 720 and some options and implementation details. Trailer 720 can be used with frame 1011 or frame 1012. It is slightly larger than trailer 720 in FIG. 7C because frames 1011, 1012 are taller than frames 721, 722. Trailer 720 comprises frame entry 112 for moving frame 1012 into the trunk of trailer 720 and out of the trunk. Frame entry 112 extends from a trunk floor 1101 almost to a trunk ceiling 1102 and from a wall at the long side of trailer 720 to the opposite wall. Frame entry 112 is closable with a roller door 1103 which is in this example in an open position (besides trunk ceiling 1102). Trailer 720 comprises a loading bridge 1104 that is in the figure in an open position and rests on a loading platform 1105. When loading bridge 1104 is in a closed position it covers a lower part of frame entry 112. A benefit of loading bridge 1104 is that it always lefts trunk floor 1101 entirely free for frames (compared to loading bridge 808).

Trailer 720 comprises a motion detector 1106 capable to detect at a picking site an approaching AVG to open roller door 1103 for the approaching AVG. Trailer 720 further comprises a location marking 1107 in the trunk. For example, AVG 1004 is adjusted to leave frame 1012 at location marking 1107 to a storing place 723. In one embodiment location marking 1107 is a bar code on trunk floor 1101. AVG 1014 can read the bar code with its bar code scanner that is placed on the bottom of AVG 1014.

While the present invention has been described in connection with a number of exemplary embodiments, measurements, and implementations, the present invention is not so limited, but rather covers various modifications, and equivalent arrangements, which fall within the purview of prospective claims.

What is claimed is:

1. A trailer for a delivery of products, the trailer comprising an attachment point (101) for attaching the trailer to a road vehicle, a body with wheels, a wall attached to the body, the wall including openings to a trunk that is limited by at least the body and the wall, and closures to cover and disclose the openings, and the trailer is configured to open at least one of the closures in response to a correct identifier input or provided by a customer, and the trailer is configured for the delivery so that a first repository in the trunk is reachable only through a first opening and a second repository in the trunk is reachable only through a second opening, the trailer further comprising a frame with the first repository and the second repository, the frame comprising a contact part for at least one of the following devices capable to propel the frame: a) a stationary loading device, b) an automated guided vehicle; and the trailer is configured to receive the frame to a storing place so that, at the storing place, the frame holds the first repository besides the first opening and the second repository besides the second opening.

2. The trailer as claimed in claim 1, wherein the trailer comprises in the trunk a location marking and the automated guided vehicle is adjusted to leave the frame at the location marking.

3. The trailer as claimed in claim 1, wherein the trailer comprises a frame entry for moving the frame into the trailer and out of the trailer.

4. The trailer as claimed in claim 3, wherein the trailer comprises a loading bridge at the frame entry.

5. The trailer as claimed in claim 3, wherein the trailer comprises a motion detector capable to detect the automated guided vehicle and the trailer is configured to open the frame entry to for the automated guided vehicle.

6. The trailer as claimed in claim 1, wherein the trailer comprises the frame with wheels.

7. The trailer as claimed in claim 1, wherein the trailer comprises the frame with legs.

8. The trailer as claimed in claim 1, wherein the trailer comprises rollers on a floor of the trunk to move the frame.

9. The trailer as claimed in claim 8, wherein the trailer comprises the frame whose bottom plate operates as the contact part for the stationary loading device) and the rollers on the floor of the trunk.

10. The trailer as claimed in claim 1, wherein the repositories in the trailer are intended for delivery of at least one of the following items: shopping bags, laundry bags, boxes, parcels.
